(19) United States
(12) Patent Application Publication
(10) Pub. No.: US 2002/0099585 A1
(43) Pub. Date: Jul. 25, 2002

(54) Optimizing business processes using cost functions

(76) Inventor: John William Locke, Mountain View, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(21) Appl. No.: 09/769,841

(22) Filed: Jan. 24, 2001

(51) Int. Cl. G06F 17/60

(52) U.S. Cl. 705/7; 705/400

(57) ABSTRACT

An apparatus, method and computer program product for use in managing the cost of a business process. It includes receiving a discontinuous cost function that describes the costs associated with the business process as a function of one or more operational parameters; finding the minimum cost point of the cost function, including dividing the cost function into continuous sections, calculating the point of minimum cost for each section, and selecting the point of minimum cost having the lowest value; and applying to the business process the operational parameters corresponding to the selected point of minimum cost.

### BACKGROUND

This invention relates to optimizing business processes, and more particularly to optimizing business processes using cost functions.

Economists describe business processes in terms of cost functions. A cost function describes the costs associated with a business process as a function of one or more operational parameters. The business process can be optimized by selecting proper values for the operational parameters.

Cost functions tend to be complex. That is, they usually include features such as abrupt changes in value or slope, and the like, that reflect similar features in the costs associated with certain operational parameters. Thus the determination of the proper operational parameters is not a simple matter.

### SUMMARY

In general, in one aspect, the invention features an apparatus, method and computer program product for use in managing the cost of a business process. It includes receiving a discontinuous cost function that describes the costs associated with the business process as a function of one or more operational parameters; finding the minimum cost point of the cost function, including dividing the cost function into continuous sections, calculating the point of minimum cost for each section, and selecting the point of minimum cost having the lowest value; and applying to the business process the operational parameters corresponding to the selected point of minimum cost.

Particular implementations can include one or more of the following features. Calculating includes choosing a plurality of control points for each section; and generating one or more approximations for each section based on the control points in that section. Generating includes selecting sets of the control points; and generating one of the one or more approximations for each set of control points. Calculating the point of minimum cost for each approximation includes finding the point of zero slope on the approximation. Generating one of the one or more approximations includes calculating an interpolation function based on the control points.

Advantages that can be seen in implementations of the invention include one or more of the following. The optimization of a cost function is broken into multiple calculations which can be calculated in parallel. Business processes can be optimized quickly and accurately.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 depicts an example cost function.

FIG. 2 is a flowchart of an optimization process according to one implementation.

FIG. 3 depicts the cost function of FIG. 1 broken into continuous sections.

FIG. 4 depicts an example two-dimensional cost function.

Like reference symbols in the various drawings indicate like elements.

### DETAILED DESCRIPTION

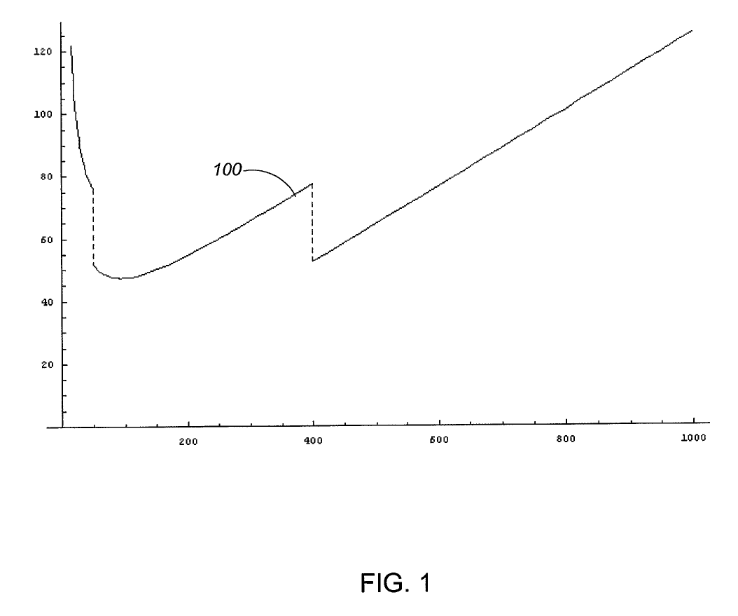

FIG. 1 depicts an example cost function 100. A cost function describes the costs associated with a business process as a function of one or more operational parameters. In the example described in detail below, the business process is the operation of a warehouse containing a stock of items, and the operational parameter is the quantity of items ordered to replenish the stock. One skilled in the relevant art will recognize that implementations of the invention are applicable to any business process. For example, implementations of the invention are applicable to the making of decisions in a supply chain.

Referring again to FIG. 1, cost function 100 describes the operation of a warehouse to house a stock of one particular category of goods, also referred to as one stock keeping unit (SKU). Cost function 100 is one-dimensional. That is, cost function 100 is a function of only one operational parameter: the quantity ordered from time to time to maintain a stock of the SKU to serve customers of the warehouse. The vertical axis represents cost in dollars. The horizontal axis represents quantity in units.

It is desirable to minimize the sum of the several costs associated with the warehousing for the SKU. The operational parameter of the warehouse operation that is to be controlled to effect the minimization of costs is the quantity of the items that is ordered to replenish the stock of the SKU. The purpose of having this warehouse is to provide a stock of the SKU sufficient to meet the demand for this SKU. Items are drawn from this stock and delivered to the customers served by the warehouse. As stock is drawn from the warehouse, the number of items in the SKU diminishes until it becomes necessary to issue a replenishment order to a source of the SKU. By choosing the optimal replenishment quantity to order, the total cost of the warehouse operation can be minimized.

Cost function 100 precisely describes the cost per unit of time to maintain the entire stock of this SKU in the warehouse as a function of the replenishment quantity. In this example, the unit of time is one day. To optimize the cost of operating the warehouse, the process locates the minimum value of cost function 100. The process then applies to the business process the operational parameters corresponding to the minimum value of the cost function. In our example, the process orders the replenishment quantity that generates the minimum value of the cost function. Alternatively, the process advises the operator of the warehouse to order the replenishment quantity that generates the minimum value of the cost function.

For the present example, assume that the demand for the SKU is steady. That is, a constant number of units of this SKU are drawn from the stock each day by customers. With a steady demand and periodic bulk replenishment, the inventory (the number of items of this SKU that is in stock at any time) follows a pattern over time that is shaped like the teeth of a saw. The inventory level rises rapidly when the items are delivered to the warehouse, and falls slowly as customers draw items from the stock. Over time, the inventory follows many cycles of rising and falling levels.

The operator of the warehouse orders replenishment units so as to receive deliveries of the items just as the stock is about to run out. The operator replenishes the stock up the same level each time. With steady demand, the length of the inventory cycle is uniform.

Cost function 100 can be generated using the following points.

Demand is constant at a rate of D items per day.

The quantity of each replenishment order is Q items.

The length of the inventory cycle is T days.

The warehouse incurs a fixed cost K dollars each time it places a replenishment order.

The cost of acquiring the goods (that is, the capital cost of the goods) is not considered a cost with respect to the optimization because the outlay is recovered from the customers when the warehouse fulfills its function by delivering its goods. However, cost savings associated with price breaks achieved for quantity purchases in replenishment are considered by lowering the cost function wherever the quantity exceeds a price-break threshold.

The cost of holding an item in inventory is h dollars per day. In general, h is the sum of three cost components:

the cost of storage based on charge per square foot of the warehouse occupied by the item;

the depreciation of the item as it sits in storage; and

the cost of capital figure as an interest rate reflecting the opportunity cost of the funds tied up in the inventory.

Now we can include particular numerical values and the accounting for price breaks. The demand is assumed to be 6 units per day. The fixed cost K incurred each time a replenishment order is placed is $180.

The capital cost of the SKU is assumed to be a base price of $200 when purchased in small quantities. When 50 to 399 items are purchased, the price is reduced by 2% of the base price to become $196. When 400 or more items are purchased, the price is reduced by a further 2% of the base price to become $192. Note that only the $4 or $8 per item discounts are considered in optimizing, not the base capital cost.

The three components comprising the holding cost are figured as follows. The storage cost component is based on the item occupying 0.3 square feet in the warehouse at a monthly cost of $1.20 per square foot. The storage cost is $0.012 per day. The depreciation component based on an assumed 35% per annum rate of depreciation, figured without compounding, is

200×35/100×365=0.19178 (1)

per item per day at the base price before price-break discounts are applied and proportionately less when goods can be bought with a discount for quantity.

The cost of capital component based on an assumed interest rate of 10%, figured without compounding, is

200×10/100×365=$0.05479 (2)

per item per day at the base price before price-break discounts are applied and proportionately less when goods can be bought with a discount for quantity.

These particular numerical values generate the cost function 100 shown in FIG. 1. Specifically, FIG. 1 shows the total cost for all of the stock of this SKU averaged over time in dollars per day as a function of the stock level. Note the discontinuities in this cost function are associated with quantities corresponding to the price-break thresholds of 50 and 400 items per replenishment order.

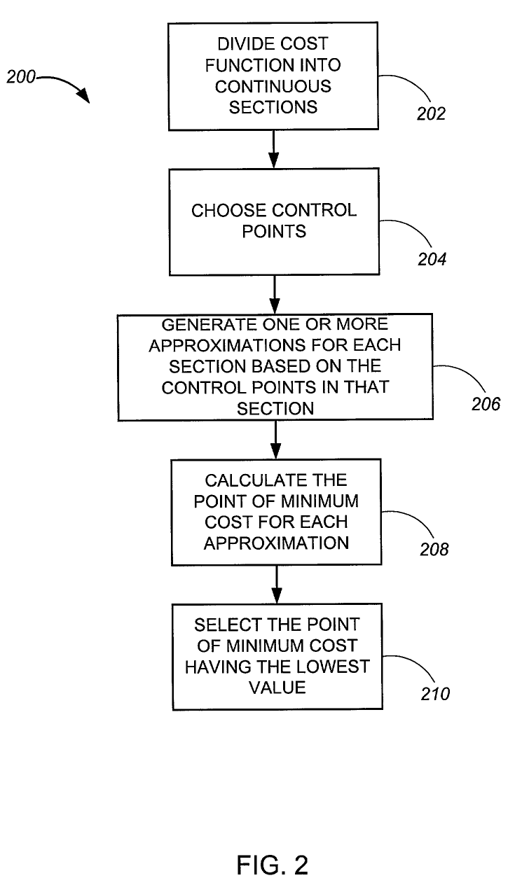

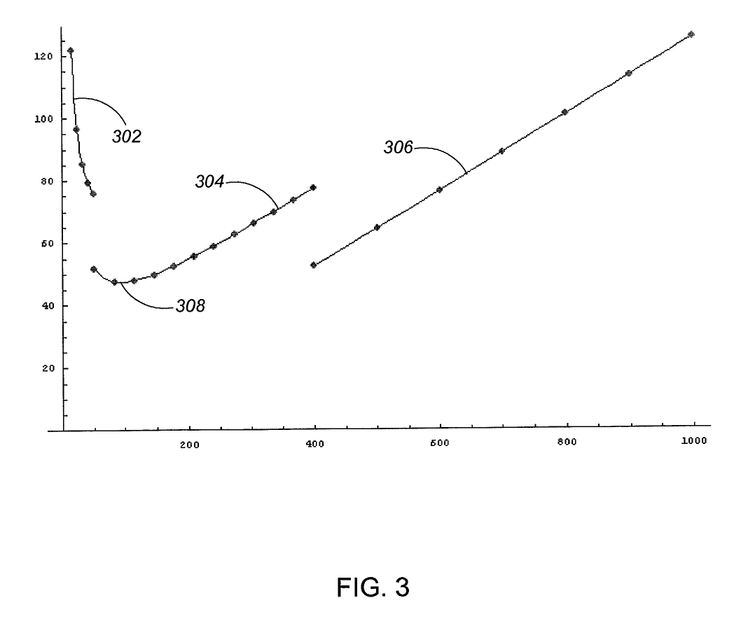

FIG. 2 is a flowchart of the optimization process 200 according to one implementation. The process divides the cost function into continuous sections (step 202). Continuous sections are separated from each other by discontinuities. Discontinuities include features such as abrupt changes in slope or value, and the like. In FIG. 3, the three sections correspond to three ranges of quantity imposed by the price breaks. Section 302 represents quantities from 15 to 50. Section 304 represents quantities from 50 up to 400. Section 306 represents quantities from 400 up to 1000.

Next the process chooses control points in each section (step 204). A control point is chosen at each end of each section. Additional control points are chosen at intermediate points. The number and location of the intermediate control points is selected according to the desired accuracy for the optimization. The number of control points chosen for the sections is 5 for section 302, 12 for section 304 and 7 for section 306. The control points in each section are evenly spaced in the x-direction. Other methods of choosing control points are within the scope of the process.

The process generates one or more approximations for each section based on the control points in that section (step 206). Each pair of adjacent control points within a section defines an interval. In one implementation, the process generates an approximation for each interval. The process generates each approximation by calculating an interpolation function.

The process chooses a type of interpolation function and calculates the parameters of that function based on the coordinates of nearby control points. The interpolation function is chosen to approximate the cost function sufficiently closely that a minimum found for the interpolation function is a good approximation for the minimum of the cost function. The interpolation function selected is a type for which an analytic method can be used to find the minimum value of the interpolation function within each interval.

In one implementation, the type of interpolation function is a cubic spline. That is, each interval of the interpolating function is a cubic polynomial given by:

y=y₀+ax³+bx²+cx (3)

with the parameters y₀, a, b and c being different, in general, for each interval. In this example, y corresponds to cost and x to quantity.

In one implementation, the following constraints are imposed on each interpolation function. The spline used here is based on requiring a match of slope and curvature between cubic intervals meeting at each internal control point. Also, the second derivatives are required to be the same at each end control point and the control point nearest that end of the section. The spline is also required to pass through each control point exactly. The constraints uniquely define all of the parameters for each interpolation function.

The process calculates the point of minimum cost for each approximation (step 208). In one implementation, the process finds points of zero slope on the approximation. Here each spline is a cubic section. To find the minimum of a cubic polynomial section such as that given by equation (3), it is convenient to calculate the derivative,

y′=3ax²+2bx+c (4)

and setting y′ to zero, solve the resulting quadratic equation to find the value of x at which the slope is zero.

3ax²+2bx+c=0 (5)

The points of zero slope on an approximation represent local minima and maxima of the approximation, and so are candidates for the point of minimum cost of the approximation. It is also possible that the global minimum of the approximation lies at one of its endpoints, and that the approximation does not have zero slope at that endpoint. The endpoints are the adjacent control points for which the approximation was generated. Therefore the endpoints of the approximation are also considered candidates for the point of minimum cost of the approximation. The candidates therefore include the points of zero slope and the endpoints. The process selects the candidate having the lowest value as the point of minimum cost for the approximation.

The process then selects the point of minimum cost having the lowest value (step 210). In this example, the point of minimum cost is found in spline 308 of section 304 at a cost y=$47.4072 and a quantity x=92.9101 items. The process then orders this quantity of items from the supplier.

The true minimum cost based on the actual cost function is y=$47.4072 (located at x=92.2815 items). Thus the result achieved by the process is accurate to $0.0005393 per day. Considering that the revenue for this SKU of $1176 per day shows the accuracy of the process.

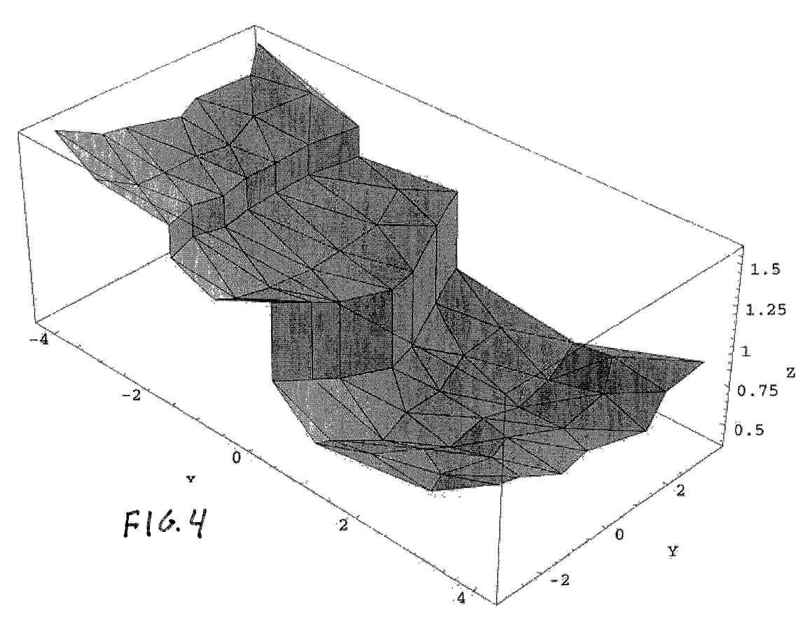

The process described above is easily applied to a cost function having multiple dimensions. For example, FIG. 4 depicts an example two-dimensional cost function. The x-axis and y-axis each represent operational parameters, and the z-axis represents cost. The cost function is a surface having two discontinuities. The interpolation technique chosen in this case is “triangular interpolation,” where the surface is divided into triangular patches. The vertices of each patch can be chosen according to well-known techniques such as Delaunay triangulation. Within each patch, the approximation surface can be planar or some more complex function. The process then operates upon the triangular patches in a manner analogous to the spline operations described above. These principles are easily extended to a cost function having three or more dimensions.

It is almost always beneficial to accelerate the planning because the calculations employed in optimization consume a large amount of expensive computer execution time. The optimization of a complex task can often take more time than the execution of the task. Also, it is normal that plans must be recalculated many times during the execution of the economic activity to revise those plans to take into account unexpected events or trends as they become known. By accelerating optimization calculations, the process supports the discovery of improved plans by making it possible to explore, evaluate and choose between more choices and more parameters in a given amount of computer execution time.

In one implementation, each section is passed to a different processor, and the sections are processed in parallel. In another implementation, each interval is passed to a different processor, and the intervals are processed in parallel. These implementations further improve the speed of the process.

This process described above can be applied to accelerate the planning for any economic activity for which it is desirable to achieve a goal while minimizing costs and/or maximizing benefits. While several implementations are described below, the invention is not limited to these implementations.

In one implementation, the business process is a search and rescue operation. The process can accelerate the initial planning and get the operation underway more quickly. It can aid in calculating such parameters as the number of search parties, the type of vehicles they will use, the geometric patterns the parties will traverse in exploring an area and the time of day when particular search methods are most effective. The optimization might be to achieve maximum likelihood of find the lost persons in the shortest search time while minimizing the cost of the operation. Where more than one measure of optimality is to be considered (shortest time and minimum cost in this example) the measures are combined by a formula that trades time against cost in a manner that satisfies the directors of the operation. The method would generate orders to the search parties and others providing logistical support detailing what each participant should do, when he should do it and what equipment he needs. The process can aid in quickly revising the search plan when further information is generated in the process of carrying out the initial orders.

In one implementation, the business process is the construction of a large structure such as a bridge or a manufacturing facility. The process can accelerate the initial planning and get the construction underway more quickly. It can aid in quickly adjusting the construction plan as weather, unexpected conditions discovered on the site and unplanned delays in the delivery of materials occur. The process can choose parameters such as the best sequence of operations, types of equipment to rent, crew assignments and alternate sources of materials. The process would generate the project plan and maintain it as unexpected conditions arise. The optimization would be aimed at completing the construction at lowest cost in the shortest time. These parameters would be used in issuing orders to the crew and orders for goods and services to outside suppliers.

In one implementation, the business process is the management of a hospital or other labor-intensive facility. On an ongoing basis, the process would be used to optimize the number of staff members of various job categories assigned to work shifts in response to varying patient needs and considering complex labor-contract business rules. The optimization would achieve a balance of the quality of patient care with a minimization of cost and waste. The process would issue work-shift assignments to doctors, nurses, technicians, cleaners, maintenance staff and clerks to operate the hospital.

In one implementation, the business process is the management of call centers. For example, call center agents of a photocopier company respond to telephone calls from customers in need of maintenance for their leased copying machines. The process can be used to optimize the number of agents and their work hours along with the number and locations of call centers to achieve a specified service level (time to answer a call and process the caller's request) at minimum total cost per year. The process would take into account complex labor-contract business rules, the type and level of computer support for the agents and telecommunication pricing in achieving minimum cost. The process would issue a plan for the construction of call center facilities, orders for computer equipment and work-shift assignments to the agents.

In one implementation, the business process is the management of an automobile assembly line painting station. The process can be used to optimize the sequence of vehicles reaching a painting station so that a minimum of clean-up and setup operations are needed when changing color from one vehicle to the next. Complex rules as to which colors may follow others are considered. The optimization would seek minimum cost. The process would generate the optimal sequence of vehicles and issue control orders to the many stations of the assembly line so that vehicles reach the painting station in the required sequence.

In one implementation, the business process is a military operation. The process can accelerate the initial planning and get the operation underway more quickly. It can aid in calculating such parameters as the number of various categories of people, equipment and weapons to be used. It can choose transportation routes as well as dates and hours to commence stages of the operation. The optimization would be focused on achieving the military objective in minimum time with a minimum number of casualties and minimum cost (with a formula that trades time, risk and cost in an appropriate manner). The process produces orders to all participants detailing when and where their services are to be provided, what equipment is to be deployed, what rules of engagement are to be in force and what scope for initiative is allowed for responding to contingencies.

In one implementation, the business process is that of a software agent engaged in electronic commerce: A software agent is a computer program which acts with a degree of autonomy to carry out activities on behalf of a human client or organization. Such an agent might act for a corporation in gathering all of the electronics parts required for a production run of the assembly of computers in response to a queue of orders for various models of such computers. The agent would perform the initial planning for the procurement of the electronics parts and issue orders to a long list of suppliers. The parts quantities and the splitting of orders across suppliers would be calculated with such considerations as price breaks for quantity orders and transportation costs. Which suppliers have stock, which suppliers can fulfill a back-order quickly, the transportation costs and delivery times are also considered. The optimization would be for a balanced combination of minimum cost and minimum time to satisfy each order in the queue. The agent would review (by e-mail and other telecommunication means) the progress of each supplier in fulfilling the orders and each transportation carrier in delivering the shipments of parts. The agent would issue modified orders to the suppliers and carriers in response to actual progress in meeting the goal of having all of the parts needed to assemble each computer on a timely basis.

In one implementation, the business process is the management of underwater archaeological exploration. In exploring an underwater archaeological site, it is desirable to locate as many artifacts as possible within a limited season of the year when weather permits, within a limited budget. Divers who might be essential in the operation can work for a limited number of hours per day in a pattern of work shifts that are determined by complex rules based on the physiology of breathing gases under pressure. The process would evaluate search patterns and strategies and issue operational orders for the divers, support ships and other logistical needs to achieve the location and recovery of the maximum number of artifacts at the least cost with maximum safety for the diving crew and complete adherence to rules for safe diving.

In one implementation, the business process is the trading of financial contracts. From an order queue (an order book) of buy and sell orders for financial instruments such as stock or bonds, the process would provide the decisions needed for a computer to choose closely-matching buy and sell orders. The optimization might minimize the average bid/ask spread while conforming to complex financial exchange rules and regulations relating to fairness and timely execution. The process would issue a sequence of matched buy and sell orders as a sequence of executed trades and issue the consequent notifications to the buyer, the seller, market maker and the overseeing regulatory authority.

In one implementation, the business process is that of a transportation carrier. The process would be used to assign shipments of goods to a combination of vehicles, routes and schedules. The optimization would be aimed at minimizing the overall cost of delivering the goods on time to a list of customers at various locations. The process would generate orders to drivers, vehicle pools and loading facilities so that the correct goods would be loaded in the best size of vehicle in time for promised delivery schedules to be met.

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

A number of embodiments of the invention have been described. Nevertheless, it will be understood that various modifications may be made without departing from the spirit and scope of the invention. For example, the process can be used to find maxima as well as minima. Accordingly, other embodiments are within the scope of the following claims.

What is claimed is:

1. An apparatus for use in managing the cost of a business process, comprising:
means for receiving a discontinuous cost function that describes the costs associated with the business process as a function of one or more operational parameters;
means for finding the minimum cost point of the cost function, including
means for dividing the cost function into continuous sections,
means for calculating the point of minimum cost for each section, and
means for selecting the point of minimum cost having the lowest value; and
means for applying to the business process the operational parameters corresponding to the selected point of minimum cost.

2. The apparatus of claim 1, wherein means for calculating comprises:
means for choosing a plurality of control points for each section; and
means for generating one or more approximations for each section based on the control points in that section.

3. The apparatus of claim 2, wherein means for generating comprises:
means for selecting sets of the control points; and
means for generating one of the one or more approximations for each set of control points.

4. The apparatus of claim 3, wherein means for calculating the point of minimum cost for each approximation comprises:
means for finding a point of zero slope on the approximation.

5. The apparatus of claim 4, wherein means for generating one of the one or more approximations comprises:
means for calculating an interpolation function based on the control points.

6. A method for use in managing the cost of a business process, comprising:
receiving a discontinuous cost function that describes the costs associated with the business process as a function of one or more operational parameters;
finding the minimum cost point of the cost function, including
dividing the cost function into continuous sections,
calculating the point of minimum cost for each section, and
selecting the point of minimum cost having the lowest value; and
applying to the business process the operational parameters corresponding to the selected point of minimum cost.

7. The method of claim 6, wherein calculating comprises:
choosing a plurality of control points for each section; and
generating one or more approximations for each section based on the control points in that section.

8. The method of claim 7, wherein generating comprises:
selecting sets of the control points; and
generating one of the one or more approximations for each set of control points.

9. The method of claim 8, wherein calculating the point of minimum cost for each approximation comprises:
finding a point of zero slope on the approximation.

10. The method of claim 9, wherein generating one of the one or more approximations comprises:
calculating an interpolation function based on the control points.

11. A computer program product, tangibly stored on a computer-readable medium, for use in managing the cost of a business process, comprising instructions operable to cause a programmable processor to:
receive a discontinuous cost function that describes the costs associated with the business process as a function of one or more operational parameters;
find the minimum cost point of the cost function, including
divide the cost function into continuous sections,
calculate the point of minimum cost for each section, and
select the point of minimum cost having the lowest value; and
apply to the business process the operational parameters corresponding to the selected point of minimum cost.

12. The computer program product of claim 11, wherein instructions operable to cause a programmable processor to calculate comprise instructions operable to cause a programmable processor to:
choosing a plurality of control points for each section; and
generating one or more approximations for each section based on the control points in that section.

13. The computer program product of claim 12, wherein instructions operable to cause a programmable processor to generating comprise instructions operable to cause a programmable processor to:
select sets of the control points; and
generate one of the one or more approximations for each set of control points.

14. The computer program product of claim 13, wherein instructions operable to cause a programmable processor to calculate the point of minimum cost for each approximation comprise instructions operable to cause a programmable processor to:
find a point of zero slope on the approximation.

15. The computer program product of claim 14, wherein instructions operable to cause a programmable processor to generate one of the one or more approximations comprise instructions operable to cause a programmable processor to:
calculate an interpolation function based on the control points.
